(19) United States
(12) Patent Application Publication
(10) Pub. No.: US 2004/0137944 A1
(43) Pub. Date: Jul. 15, 2004

(54) Cellular telephone with text telephone functionality and method thereof

(76) Inventors: Jimmy Zhi-Ming Lee, Miramar, FL (US); Danilo Ong Tan, Pembroke Pines, FL (US); Ravikumar Padmanabham, Anakapalli (IN)

Correspondence Address: Scott M. Garrett, Motorola, Inc., Law Department, 8000 West Sunrise Boulevard, Fort Lauderdale, FL, 33322, US

(21) Appl. No.: 10/342,564

(22) Filed: Jan. 15, 2003

(51) Int. Cl. H04M 1/00; H04B 1/38

(52) U.S. Cl. 455/557; 455/550.1

(57) ABSTRACT

A radio communication device (102) provides for full TTY functionality by providing TTY capture (526) and TTY mapping (528) that allows the communication device (102) to transmit and receive TTY data. An external keyboard (108) provides for additional ease of use in TTY character entry. A method is also provided for the communication device (102) to transmit and receive TTY data. Optionally, a keyboard detection circuit can detect if the external keyboard (108) is connected to the radio communication device (108) and if so, transmit any TTY data that has been entered, or alternatively if no keyboard is connected, send the TTY data to a connector (510) so that the data can be sent to an external TTY.

### TECHNICAL FIELD

This invention relates in general to the field of radio communications. More particularly, this invention relates to a cellular telephone that provides for Text Telephone (TTY) functionality, and a method thereof.

### BACKGROUND

A TTY is a communication device that allows people who are deaf, speech-impaired or hard of hearing to use a telephone to communicate. When using a TTY with the public switched telephone network (PSTN), the telephone handset is placed onto acoustic cups found on the TTY or the TTY is directly plugged into the telephone line outlet. When a message is typed on the TTY, the message is sent over the telephone line and presented on the display of the receiving parties TTY. Special relay services, like the Telecommunications Relay Service (TRS) allows a person without a TTY to communicate with a deaf person equipped with a TTY.

In the United States, TTY devices transmit using an asynchronous code called the Baudot code, which expresses characters using five bits. The Baudot code uses two code sub-sets, the “letter set” and the “figure set” to give 2×2⁵=64 TTY characters. Two of the 64 Baudot character combinations are used to select between the letter and figure sets. Each TTY character consists of a START bit, 5 data bits, and a STOP bit. The duration of each Baudot bit is 22 milliseconds for 45.45-baud operation and 20 milliseconds for 50.0-baud operation at a sampling rate of 8 kilohertz (KHz).

With the rapid increase usage of digital cellular telephones in the last decade, many cellular telephones today have the ability to connect to a TTY via a cable. The cellular telephone provides a wireless link to another TTY user via the cellular system. When using a TTY compatible cellular telephone, the TTY is connected to the cellular telephone using a cable.

There are several problems that can occur when using a cellular telephone connected to a TTY:

A. Signal-level variation—since there are no strict standards applied on TTY manufacturers for making TTY devices, the signal level outputted by the TTY to the cellular telephone is dependent on the particular TTY device being used. This variation in signal-level introduces false detections and hence higher character-error-rate on both inbound and outbound signals;

B. False detection—a TTY Baudot character consists of a START bit, 5 data bits, and at least one STOP bit. Each Baudot bit is represented by a tone of 1400 Hertz (Hz) for a binary “1” or 1800 Hz for a binary “0”. This requires that a tone detection-and-decision algorithm be provided in the cellular telephone to decode the data being sent by the TTY. This type of algorithm can introduce false detections and therefore introduce errors in the transmission and/or reception of the data; and

C. Carrying multiple devices—a user who needs to use a TTY device using a cellular telephone to communicate has to carry the TTY, cellular telephone and interconnection cable. This of course presents problems to some users.

Given the above problems, a need exists for a radio communication device such as a cellular telephone that can help minimize or eliminate some or all of the above mentioned problems.

### BRIEF DESCRIPTION OF THE DRAWINGS

The features of the present invention, which are believed to be novel, are set forth with particularity in the appended claims. The invention, may best be understood by reference to the following description, taken in conjunction with the accompanying drawings, in the several figures of which like reference numerals identify like elements, and in which:

FIG. 1 shows a diagram of a cellular telephone and keyboard combination in accordance with the invention.

FIG. 2 shows a flow diagram highlighting the steps taken during inbound TTY communications in accordance with the invention.

FIG. 3 shows the display of the cellular telephone shown in FIG. 1 with a split display screen in accordance with one embodiment of the invention.

FIG. 4 shows a flow diagram highlighting the steps taken during outbound TTY communications in accordance with the invention.

FIG. 5 shows a block diagram of a communication device in accordance with the invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures.

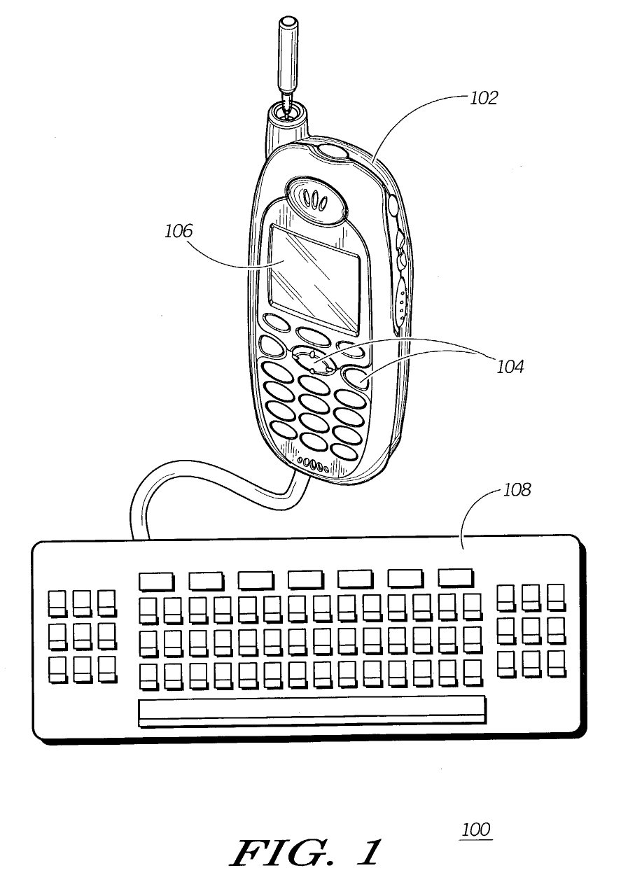

Referring now to FIG. 1, there is shown a diagram of a radio frequency communication device such as a cellular telephone 102 that has built-in TTY functionality in accordance with the invention. Other cellular communication devices such as wireless personal digital assistants (PDA) can also take advantage of the present invention. Cellular telephone 102 has the capability of encoding and decoding Baudot code and displaying the inbound and outbound TTY communications to the user. Cellular telephone 102 includes control keys (keypad) 104 and display 106. Cellular telephone 102 is shown connected to an optional external foldable keyboard 108 which can be used in place of the control keys 104 located on cellular telephone 102.

Cellular telephone 102 and keyboard 108 form a TTY communication system in accordance with the invention. Keyboard 108 makes it easier for a user to enter data while in the TTY mode. Keyboard 108 can for example be an iBoard™ manufactured by Motorola, Inc. A connector (not shown) located at the bottom of cellular telephone 102 interconnects to a connector (not shown) located on keyboard 108.

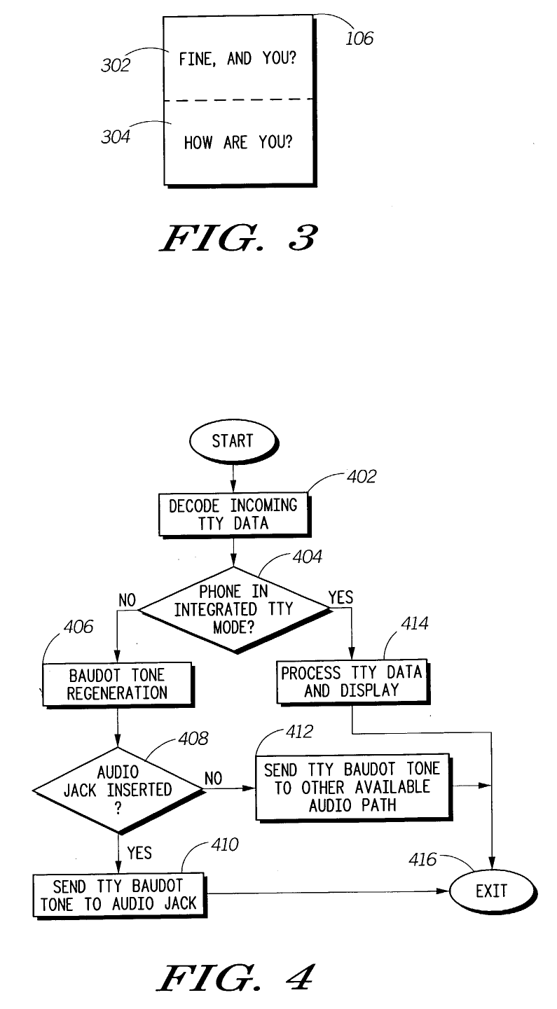

The telephone user via a functionality menu presented on display 106 and selected using control keys 104 can place cellular telephone 102, in the integrated TTY mode whereby the telephone can encode and decode TTY data. Preferably, cellular telephone 102 will have a user selectable functionality menu where a user can select to have the integrated TTY feature ON or OFF. When the integrated feature is selected ON, cellular telephone 102 will automatically enter the TTY mode of operation when the connection of an external keyboard 108 is detected and while phone 102 is “in-call” (e.g., has established a call with another cellular telephone) in one embodiment. When telephone 102 is in “out-of-call” (e.g., phone in ideal mode), the detection of an external keyboard will not change the display 106 into two portions (as shown in FIG. 3), etc. Although this mode would only be practical for users who only use the external keyboard 108 when they need to send out TTY messages. It is worth noting that if the telephone has a keypad like cellular telephone 102, an external keyboard although desirable, is not necessary, since the user can type in his TTY messages using keypad 104.

Once the TTY mode of operation is selected, the user can make a conventional call as usual in this case to another user having TTY capability. Once the call is connected, the display 106 will be cleared and all or almost all of the normal display icons will be cleared except for example the signal and battery level indicators. In FIG. 3, there is shown an illustrative example of how the display area is preferably split into two portions; a first portion 304 that displays what is entered by the user via keyboard 108 and a second portion 302 which displays any TTY messages that are received by cellular telephone 102.

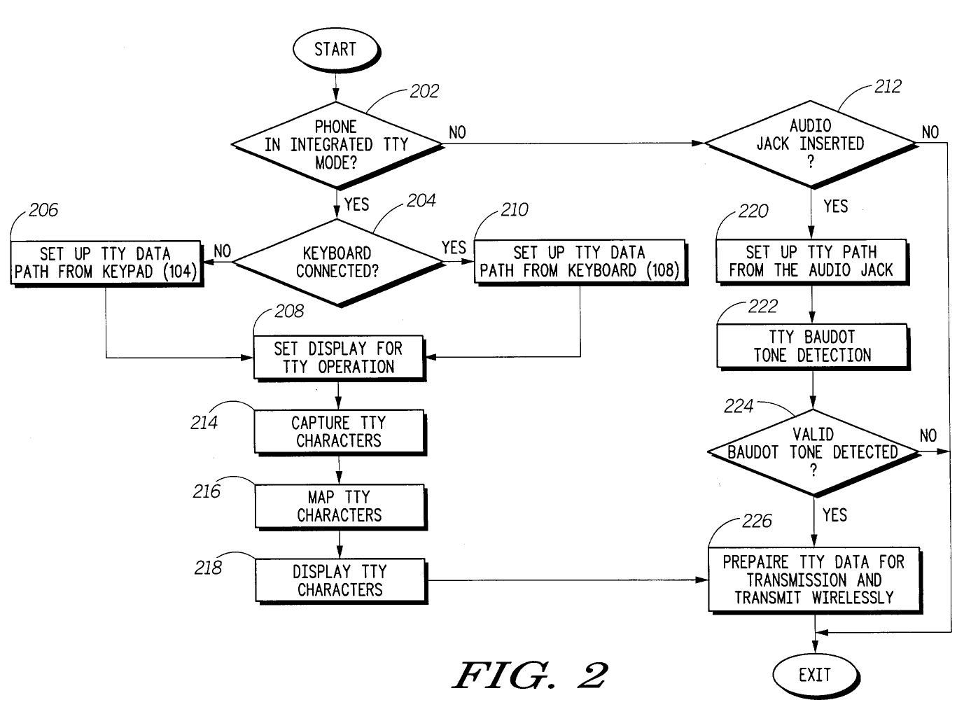

In FIG. 2, there is shown a flow diagram of steps taken for inbound TTY communications for cellular telephone 102. Inbound TTY communications are communications originating from the cellular telephone 102. If it is determined in step 202 that the cellular telephone 102 is in the integrated TTY mode, the routine moves to step 204 and determines if external keyboard 108 is connected to the telephone. If external keyboard 108 is connected to the cellular telephone 102, the routine moves to step 210 where the TTY data path is set from keyboard 108. If the external keyboard 108 is not connected to the telephone 102, the TTY data path is set for the built-in keypad 104 in step 206 and any key presses from the keypad 104 will be assumed to be a TTY message that is being typed in.

In step 208, the display 106 is set for TTY operation as shown in FIG. 3. Text entered either via keypad 104 or keyboard 108 is captured in step 214 using a character capture routine and mapped into TTY characters in step 216. The characters are mapped using a mapping routine stored in the cellular telephone since TTY does not support all ASCII characters. The TTY characters are displayed in display 106 in step 218. In step 226, the TTY data is prepared using some type of conventional voice coder scheme for transmission and transmitted using the cellular telephone's transmitter section

If in step 202 it is determined that the cellular telephone 102 is not in the integrated TTY mode, the routine moves to step 212 where it is determined if an external TTY is connected to a connector (connector 510 in FIG. 5) found in the cellular telephone. If it is determined in step 212 that an external TTY is not connected to the cellular telephone, the routine exits. If an external TTY is connected to the cellular telephone 102, the TTY path is set from the connector. Baudot tones sent from the external TTY are detected in step 222. If it is determined in step 224 that a valid Baudot tone has been detected, the cellular telephone in step 226 prepares the TTY data using some type of voice coder scheme for transmission and transmits the TTY data using the cellular telephone's transmitter. If in step 224 it is determined that the tones detected are not valid Baudot tones, the routine exits.

As previously mentioned, two of the sixty-four combinations provided by the five bit Baudot code are used to shift between the “letter” set and the “figure” set. For example, the binary code “01010” can either represent an “R” or a “4”, depending if the figure shift code “11100” or the letter shift code “11111” has been detected. The capturing and mapping of the inputted text data will be preferably handled by software routines executed by a controller found in cellular telephone 102 since the display is directly connected to the controller. Once the inputted data is mapped into TTY characters in step 216 they are displayed in step 218 so that the user knows what he has typed. In this example, the data typed in by the user is displayed in the first display portion 304 shown in FIG. 3 in step 218. Characters entered by the user via keyboard 108 which are not characters supported by the Baudot code as determined in step 224 in an alternate embodiment can be ignored and an audible alert like a short beep can be sounded to alert the user that the character is not a TTY acceptable character. Alternatively, a special Baudot-character-only keyboard can be used.

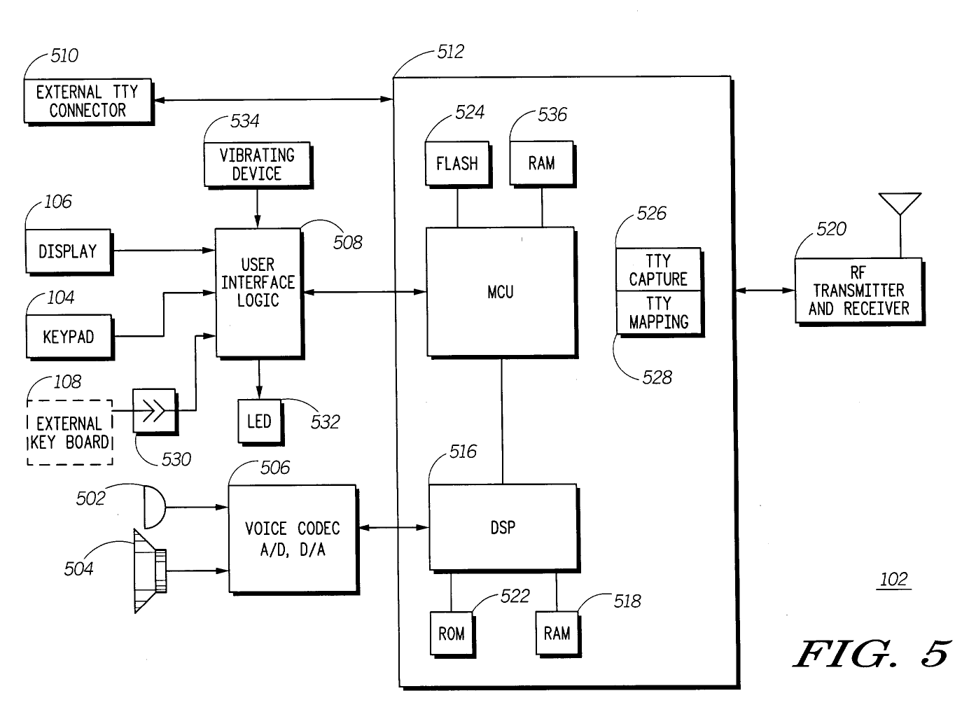

Referring now to FIG. 4, there is shown a flowchart highlighting the steps taken during outbound communications, which are communications that are received by the cellular telephone 102. In step 402, the cellular telephone 102 decodes any incoming TTY data that are embedded within some type of voice coder scheme. When an incoming TTY message is received, the cellular telephone 102 can provide visible (e.g., flashing LEDs), and/or a vibratory feature to let a deaf person, and/or an audio alert to let a speech-impaired person, know that there is an incoming call. In step 404, it is determined if the cellular telephone 102 is in the integrated TTY mode, if the cellular telephone is in the TTY mode, in step 414, the cellular telephone 102 processes (decodes, etc.) the received TTY data and displays it on the telephone's display 104, the routine is then exited in step 416.

If in step 404 it is determined that the telephone 102 is not in the integrated TTY mode, in step 406 the telephone performs Baudot Tone regeneration using TTY tone generation software stored in the telephone. In step 408 it is determined if an audio jack is inserted into the external TTY connector (see connector 510 in FIG. 5) found in the cellular telephone. If it is determined that an external TTY is connected to connector 510, the regenerated TTY Baudot tones are sent to the external TTY device via the audio jack in step 410, and the routine is exited in step 416. If an audio jack is not inserted into the external TTY connector (no TTY connected to the cellular telephone), the Baudot tones can alternatively be sent to another audio path in step 412 depending on the particular design.

Referring now to FIG. 5, there is shown a block diagram of a radio communication device such as cellular telephone 102. Cellular telephone 102 preferably includes a controller section 512 that can include a microprocessor or micro-controller unit (MCU) 514 and a digital signal processor (DSP) 516 that performs the voice and audio processing. The DSP 516 can include Read Only Memory (ROM) 522 and Random Access Memory (RAM) 518. MCU 514 can also include flash memory 524 and RAM 536 for storing information. A conventional RF transmitter and receiver section 520 provides for the transmission and reception of RF signals. Connected to controller section 512 is an external connector 510 that is used to couple TTY data to an external TTY. The display 106, keypad 104, vibrating device (silent alarm) 534, Light Emitting Diode (LED) 532 and External keyboard 108 are coupled to the controller 512 via a user interface logic circuit 508 that provides all of the necessary interface circuitry in order to couple these device to the controller section. A connector 530 allows external keyboard 108 to be connected to user interface logic 508.

A conventional voice codec and analog-to-digital (A/D) and digital-to-analog (D/A) section 506 is provided to interface the controller 512 to a microphone 502 and a speaker 504. Controller 512 executes the necessary TTY capture 526 and TTY mapping 528 routines that are stored in memory and executed by MCU 514 and/or DSP 516. The keyboard detection circuit can preferably reside in user interface logic 508.

Since there are no tone detection circuitry to worry about, and only character capturing using the present invention, false detection on Baudot codes is eliminated. Having an integrated TTY capability built-into the cellular telephone 102, avoids all of the problems previously mentioned with having to connect a cellular telephone to a TTY device, and provides for reliable transmission and reception of the Baudot codes used in TTY transmissions. It also gives TTY users the flexibility to only have to use one device for both regular and TTY communications. Providing in another embodiment of the invention for the automatic detection of an external keyboard 108 and placing the telephone in a TTY mode automatically when it is detected that the keyboard 108 is connected to connector 510 provides for further ease of operation.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for providing Text Telephone (TTY) functionality in a cellular telephone having a display, comprising the steps of:
(a) placing the radio communication device in a TTY mode so that it can receive and transmit TTY messages;
(b) setting the display so that it can display both incoming and outgoing TTY messages; and
(c) capturing and mapping characters that are inputted into the cellular telephone into TTY characters.

2. A method as defined in claim 1, wherein the cellular telephone includes a connector for connecting an external keyboard to the cellular telephone and the cellular telephone is automatically placed into the TTY mode as soon as the cellular telephone detects that the external keyboard is connected to the cellular telephone.

3. A method as defined in claim 1, further comprising the step of:
(d) displaying the characters that are captured and mapped into TTY characters.

4. A method as defined in claim 1, wherein prior to step (b) it is determined if either an external keyboard or a keypad that is part of the cellular telephone will be used to input TTY characters.

5. A method as defined in claim 3, further comprising the steps of:
(e) preparing the captured and mapped TTY characters for transmission; and
(f) transmitting the mapped TTY characters.

6. A method as defined in claim 3, wherein the cellular telephone decodes any TTY message that is transmitted to the cellular telephone.

7. A method as defined in claim 6, wherein the cellular telephone's display is divided into two sections, and the TTY messages that are received are displayed in one section, and the TTY characters that are inputted into the cellular telephone are displayed in the second section.

8. A method as defined in claim 1, wherein step (a) is performed by the cellular telephone user selecting from a functionality menu provided by the cellular telephone.

9. A cellular telephone, comprising:
an interface for receiving characters;
a controller coupled to the interface for capturing the characters and mapping the characters into TTY characters; and
a display for displaying the TTY characters.

10. A cellular telephone as defined in claim 9, further comprising:
a receiver for receiving TTY messages, coupled to the controller;
the controller decoding the TTY messages and presenting the TTY messages on the display.

11. A cellular telephone as defined in claim 10, wherein the controller causes the received TTY messages to be displayed on one portion of the display and the TTY characters that are received through the connector on a second portion of the display.

12. A cellular telephone as defined in claim 9, further comprising:
an external keyboard coupled to the interface, the keyboard providing the characters to the interface.

13. A cellular telephone as defined in claim 9, further comprising a transmitter coupled to the controller for transmitting the TTY characters.

14. A cellular telephone as defined in claim 9, further comprising:
a receiver coupled to the controller for receiving incoming TTY data; and
the controller decodes the incoming TTY data and determines if the cellular telephone is in a TTY mode and if it is processes the decoded TTY data and displays it in the display.

15. A cellular telephone as defined in claim 9, further comprising:
a receiver coupled to the controller for receiving incoming TTY data; and
the controller decodes the incoming data and determines if the cellular telephone is in a TTY mode, and if it is not, the contoller performs Baudot Tone regeneration on the decoded TTY data.

16. A cellular telephone as defined in claim 15, further comprising:
a connector coupled to the controller, the connector is used for coupling to an external TTY; and
wherein the regenerated Baudot Tones are forwarded to the connector.

17. A TTY communication system, comprising:
a cellular telephone that can provide for TTY functionality, the cellular telephone having a display;
a keyboard coupled to the cellular telephone for entering characters that are to be transmitted by the cellular telephone as part of a TTY message; and
the cellular telephone upon receiving a TTY message decodes the message and presents the message on the display.

18. A TTY communication system as defined in claim 17, wherein the cellular telephone presents the TTY characters entered via the keyboard in a first portion of the display and presents the TTY messages that are received by the cellular telephone on a second portion of the display.

19. A TTY communication system as defined in claim 17, wherein the cellular telephone is automatically placed in a TTY mode once the keyboard is connected to the cellular telephone and the cellular telephone currently has a call established.

20. A TTY communication system as defined in claim 17, further comprising:
a controller that is part of the cellular telephone, the controller captures and maps into TTY characters, characters entered into the cellular telephone via the keyboard.
